(19) United States
(12) Patent Application Publication
(10) Pub. No.: US 2009/0319427 A1
(43) Pub. Date: Dec. 24, 2009

(54) Methods for electronic payments using a third party facilitator

(76) Inventors: Jeffrey Gardner, Nashville, TN (US); Jeffrey Slusser, Columbia, TN (US)

Correspondence Address: TRIANGLE PATENTS, P.L.L.C., P.O. BOX 28539, RALEIGH, NC, 27611-8539, US

(21) Appl. No.: 12/214,881

(22) Filed: Jun. 23, 2008

(51) Int. Cl. G06Q 20/00

(52) U.S. Cl. 705/44; 705/35

(57) ABSTRACT

Methods for processing payments electronically over a network-based system wherein a third party or intermediary simplifies payment transactions by making them on behalf of individuals to the end payment recipient without providing individual account information as the basis for the payment.

### BACKGROUND OF THE INVENTION

1. Field of the Invention

The present invention relates generally to electronic financial transactions processed over a network-based system. More particularly, the present invention relates to methods for electronic payment transactions processed over a network-based system using a third party facilitator to complete the transactions.

2. Description of the Prior Art

Generally, it is known in the art to conduct financial transactions using a network-based system for transmitting and receiving electronic payments. By way of example, it is known to make electronic payments over a network such as the Internet by transactions involving payments from individuals' and business' credit, debit, prepaid, ATM card, PayPal account, Bill Me Later account, or other electronic payment methods (“Electronic Payment”).

More specifically, concerning government-related transactions, particularly in the US, most systems do not provide for individual payments to be made using credit cards or other electronic payment methods, such as emerging electronic payment methods for making payments through non-traditional third parties other than banks, credit cards, etc., even though they are commonly used in online commerce for making payments for everything from services to goods. By way of example, presently, the US Internal Revenue Service (IRS) and other state income tax departments allow individuals to make electronic payments using their credit cards and debit cards (“Cards”) through various third party organizations. These third party organizations collect funds from a number of individuals by electronically charging their Cards. The organizations then make lump sum, bulk, pooled, or batch payments to the taxing authority, based on a separate payment file or multiple files, for all individuals paying within a specific time period using the third party's own bank accounts.

Relevant art documents describe methods of completing 1-to-1 monetary transactions electronically through a third party, as well as documents that generally pertain to the electronic transfer of funds through a third party; however, these documents generally describe electronic payment methods and systems, and do not provide for the particular features and benefits of the present invention, including the collection of payments from individuals and payment to government entities without batching or pooling the payments and providing a payment data for reconciliation and or funding. Examples of such relevant art documents include:

U.S. Pub. No. 2008/0097878—System and method for payment of estimated tax due, which teaches a system and method for estimating and paying income taxes consisting of: a means of receiving financial information for an individual; calculating the estimated tax due on the individual's income; occasionally withdrawing an amount of money from the individuals' account; placing withheld funds in a secondary account until the funds available in the secondary account equal or exceed the estimated tax liability; transferring the final amount of money in the secondary account to the applicable taxing authority.

U.S. Pub. No 2002/0013747—Method and apparatus for electronic filing of income tax returns by a taxpayer, which teaches a method and free standing device to allow an individual to enter data, prepare tax returns, file tax returns, and remit payment or receive a refund. The method includes provisions for the applicable transfer of funds through a remote service provider, other third party, or by smart card.

U.S. Pat. No. 6,202,052—Fully-automated for tax reporting, payment and refund. U.S. Pat. No. 6,697,787—System for collecting tax data, which teaches system in which an electronic intermediary processes, reports, and arranges for the appropriate transfer of funds in the form of payment or refund involving: receipt of tax data by the intermediary; processing of said data and subsequent preparation of tax return; filing the tax return; arranging for the appropriate transfer of funds (payment or refund).

U.S. Pub. No 2001/0037268—Fully-automated system for tax reporting, payment and refund and system for accessing tax information, which provides method and system for gathering information form sources to assemble tax information on individual taxpayers, preparing tax returns based on acquired information, filing the return with taxing authorities, and connecting to a financial institution to pay any liability or receive a refund.

Thus there remains a need for a system and methods for processing payments electronically over a network-based system wherein a third party facilitates the transactions in order to simplify and enable the processing where individual users would not otherwise be able to participate or complete the transaction directly, or where individual payments made through an intermediary to simplify the processing and extend the electronic payment options, as with the government example, without requiring the extensive integration on the part of the payment recipient. There also remains a need for facilitate individualized Electronic Payments to be made to government entities, such as the IRS, state tax departments and other applicable industries (e.g., mortgage payments) through a third party without the third party having to pool, batch, or group multiple payments and requiring the receiving party to utilize payment data for reconciliation and/or funding.

### SUMMARY OF THE INVENTION

The present invention is directed to methods for processing payments electronically over a network-based system, such as Internet, phone, wireless communications, and other channels, wherein a third party or intermediary facilitates payment transactions in order to simplify and enable the processing of payments on behalf of individuals through all types of electronic, network-based payment methods without requiring payment integration by the payment recipient.

One aspect of the present invention provides a method for processing payments electronically over a network-based system including the steps of:

(a) initiating a transaction for making a payment on behalf of an individual;

(b) receiving authorization for receiving payment from an individual account; and

(c) providing payment data from an intermediary account to a payment recipient relating to the transaction for making the payment on behalf of the individual by an intermediary, facilitator, or third party.

Multiple payments for individual accounts may be involved, wherein the intermediary collects payments from the multiple individual accounts and makes the payment to the payment recipient without including individual account information as a basis for the payment for each individual. Third party account information is provided for each transaction by the third party or intermediary.

A second aspect of the present invention is to provide systems and methods for facilitating individualized Electronic Payments to be made to government entities, such as the IRS, state tax departments and other applicable industries (e.g., mortgage payments) through a third party without the third party having to pool multiple payments or requiring the receiving party to accept a separate payment file, if applicable, for reconciliation.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a PRIOR ART flow diagram illustrating steps for making a payment to a government entity by an individual.

FIG. 2 is a flow diagram illustrating steps for making electronic payments by an intermediary on behalf of at least one individual to a payment recipient, according to one embodiment of the present invention.

FIG. 3 is a PRIOR ART flow diagram.

FIG. 4A and FIG. 4B form a continuous (connected) flow diagram of PRIOR ART methods for credit card integrated file and bulk payment to payment recipient for an IRS example.

FIG. 5 shows a flow diagram for methods according to the present invention for a charge and refund process, using a tax payment example.

FIG. 6 shows a flow diagram for methods of the present invention for authorization and settlement relating to a tax payment example.

### DETAILED DESCRIPTION

The term “payment” or “payments” as used hereinbelow in the detailed description of the invention and preferred embodiments is defined as a financial transaction that may either be a debiting from an account or a transfer initiated from that account.

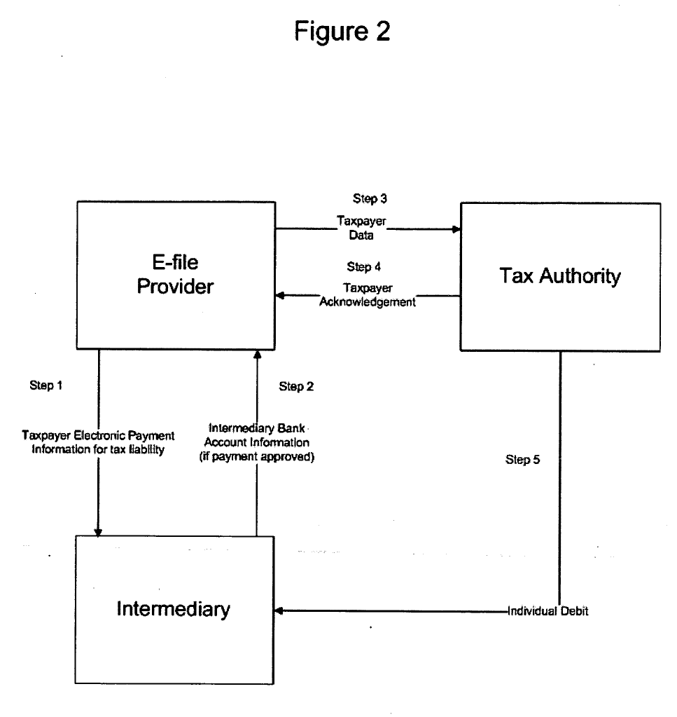

Referring now to the drawings in general, the illustrations are for the purpose of describing a preferred embodiment of the invention and are not intended to limit the invention thereto. The present invention provides methods of electronically processing individual income tax payments through a third party. More specifically, as illustrated by the flow diagram of FIG. 2, the present invention provides a method for making financial transactions including the steps of: providing a network for making electronic data communications, including secure transmission of payment data for transmitting payments between an intermediary and a payment recipient, with the payment being made by the intermediary on behalf of at least one account payor where payment to the intermediary is made by respective account payor; initiating a transaction over the network for making an electronic payment on behalf of at least one account payor owing the payment recipient; receiving authorization for receiving payment from at least one account payor; providing payment data to the payment recipient relating to the payment made directly by the intermediary on behalf of the at least one account payor, wherein the payment data includes information relating to an intermediary account, and expressly does not include bank account information relating to any of the account payors. Optionally, an additional step of receiving confirmation of the payment data processing by the payment recipient may be included. Alternatively and also optionally, an additional step of receiving notice of a declined transaction is provided.

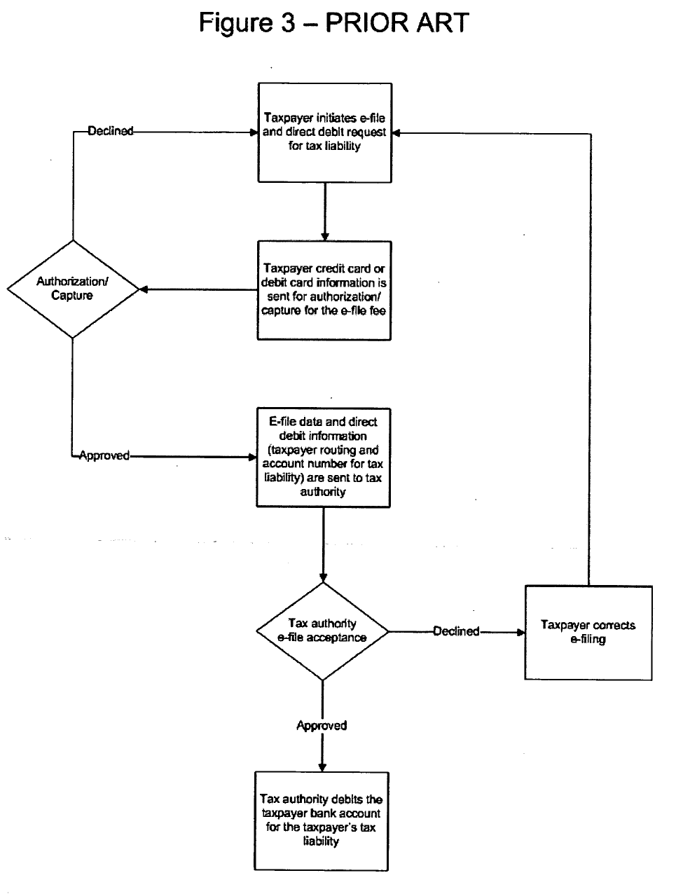

FIG. 3 is a PRIOR ART flow diagram illustrating a tax liability bank account direct debit (not credit card) process wherein the individual payor account information is provided to the payment recipient for a tax payment example.

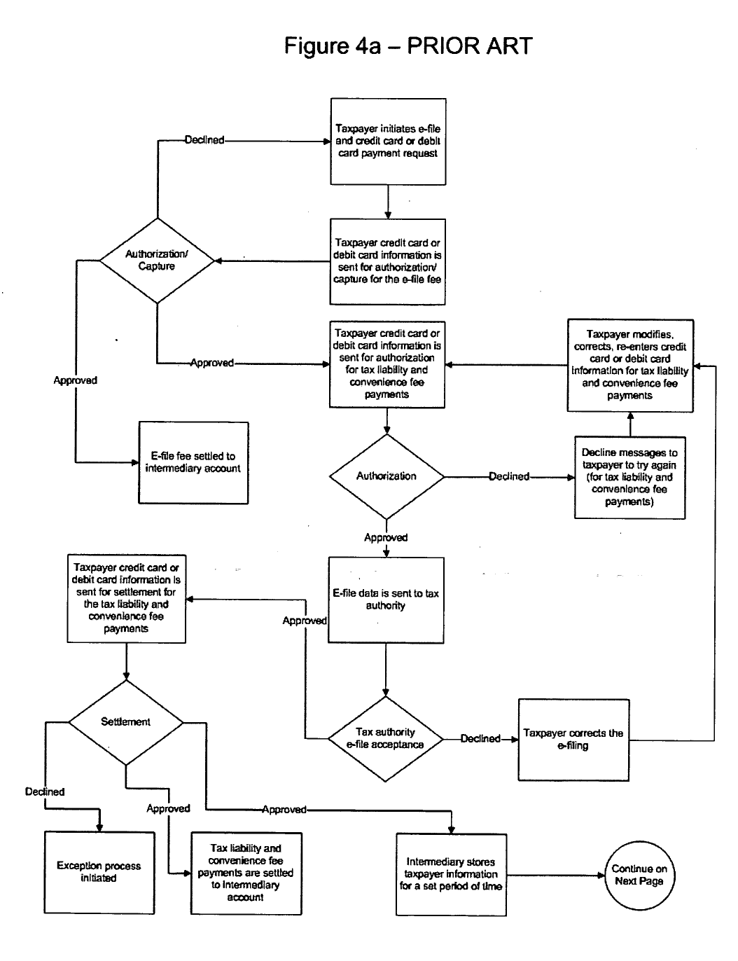

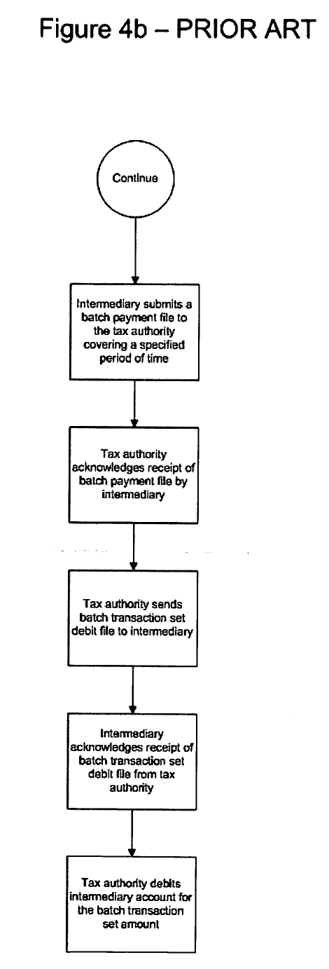

FIG. 4A and FIG. 4B form a continuous (connected) flow diagram of PRIOR ART methods for credit card integrated file and bulk payment to payment recipient for an IRS example. In this extended flow diagram, a credit card integrated file and bulk payment filer process is illustrated, including the individual payor (taxpayer) provides his/her own individual credit card or debit card information for making the payment directly to the payment recipient (IRS, in this example). Note that for reconciliation, the tax authority (payment recipient) requires integration for the electronic filing process and the credit card bulk filer process. If there is an intermediary, it must submit a batch payment file in order for the tax authority to reconcile taxpayer data to the bulk payment amount. In order to add other electronic payment methods (other than credit or debit card), the tax authority must make payment file modifications for each request. This adds development, testing, and costs for the tax authority, and thus, may prevent other forms of electronic payments from being accepted, including credit cards in some cases.

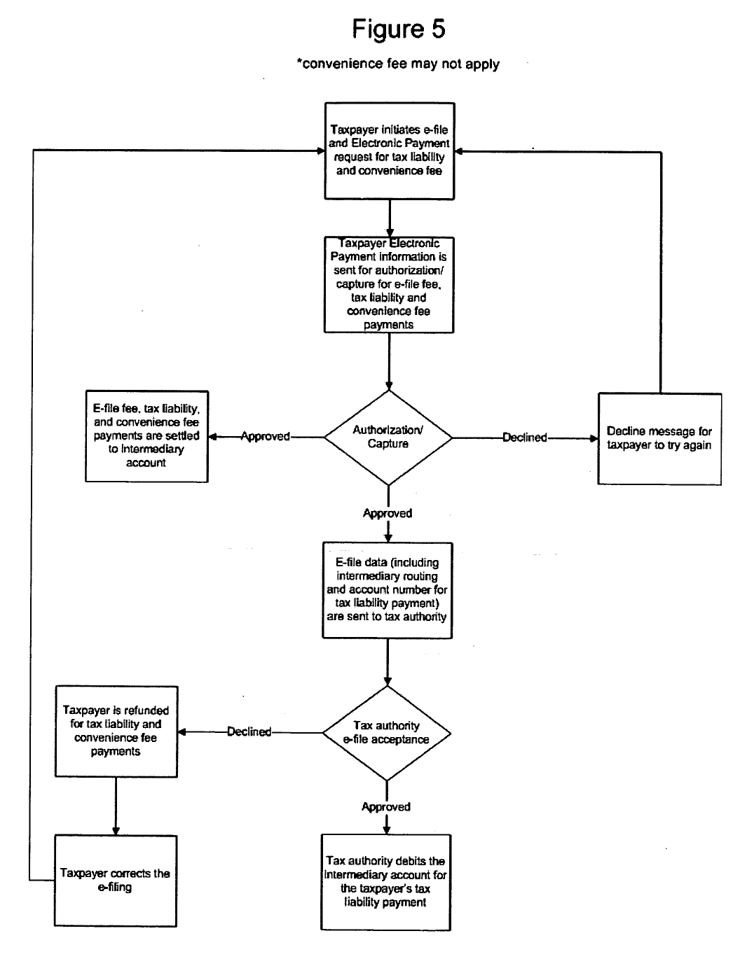

FIG. 5 shows a flow diagram for methods according to the present invention for a charge and refund process, using a tax payment example. Note that for reconciliation, the tax authority does not need a payment file or transaction record for reconciliation, because the individual taxpayer electronic filing data is validated by the tax authority (payment recipient) and the individual debit occurs after the acceptance of the electronic filing; at that time, the tax authority (final or end customer or payment recipient) debits the intermediary account, who pays on behalf of the individual payor (taxpayer).

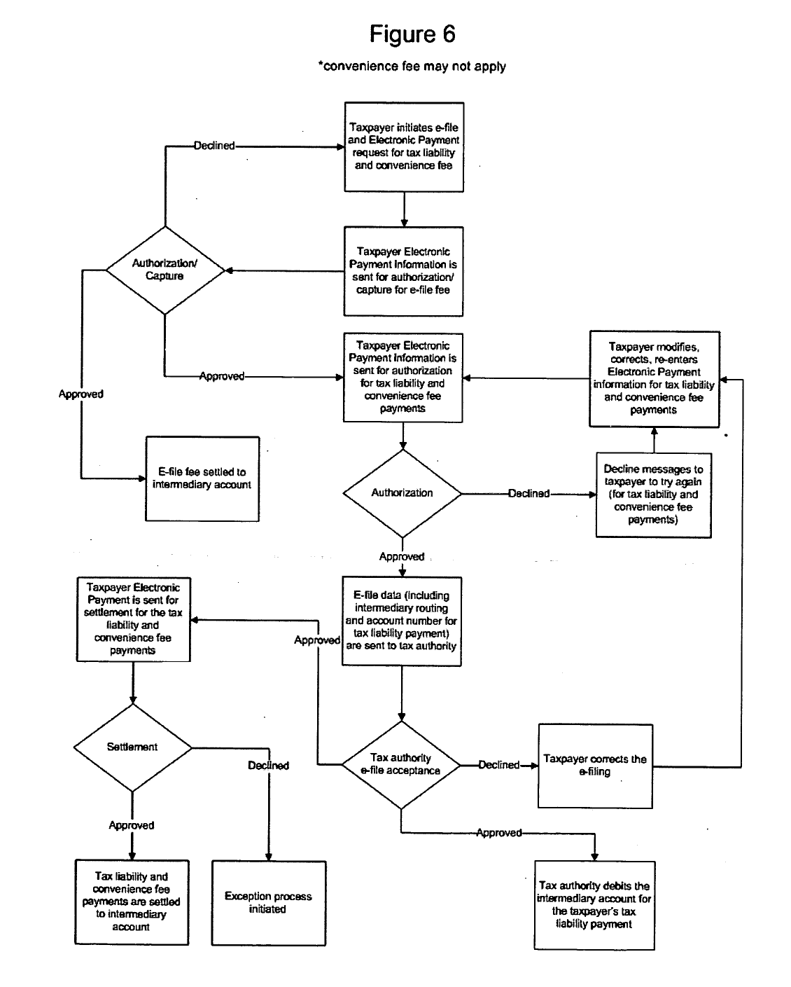

FIG. 6 shows a flow diagram for methods of the present invention for authorization and settlement relating to a tax payment example.

With the present invention methods, individuals are able to make electronic payments through a third party or intermediary, wherein the third party or intermediary collects funds in support of payments due by the individuals from each respective individual's accounts by electronically charging their credit cards or debiting bank accounts, or any other form of payment. The third party or intermediary then provides for a payment to the payment recipient on behalf of individuals, who have already authorized payment or have made payment directly to the intermediary within a predetermined time period using their respective individual bank accounts. Importantly, the present invention provides for the third party or intermediary payment to be made directly to the payment recipient without providing any bank account, credit or debit card account, or prepaid card information associated with any of the individuals to the payment recipient. Preferably, each payment to the payment recipient is made by the intermediary using the intermediary account information on behalf of the individuals. The intermediary provides an intermediary account or payment data for making the payment on behalf of individuals for whom payment to the intermediary has been approved; third party or intermediary account information is provided for each transaction by the third party or intermediary to the payment recipient. The intermediary provides information for the payment recipient (such as the IRS) to receive payment on behalf of the individual from the intermediary or third party, but this is done without transmitting or including individual payor bank or credit/debit card account information from the individual to the payment recipient. The methods of making payment by an intermediary on behalf of individuals greatly facilitates the transaction overall, and increases the options by which an individual can make payment to certain payment recipients that do not accept individual electronic payments or specific types of electronic payments. Multiple payments for individual accounts may be involved, wherein the intermediary collects payments from the multiple individual accounts and makes the payment to the payment recipient without including individual account information as a basis for the payment for each individual. Third party account information is provided for each transaction by the third party or intermediary.

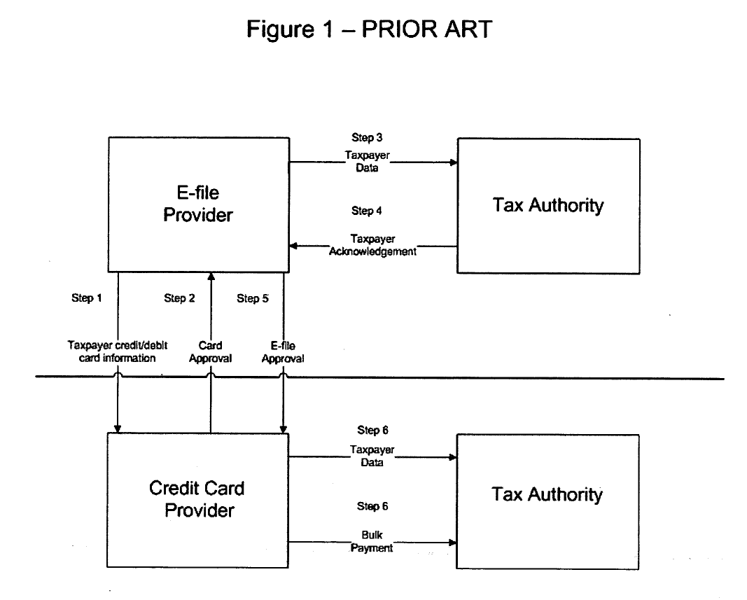

By contrast to the present invention, as illustrated by the PRIOR ART FIG. 1 flow diagram, it is known for individuals such as individual taxpayers to make electronic filing of forms including payments. However, these transactions associated with the electronic filing and payment requires the government agency to collect funds from each individual by electronically debiting bank accounts individually or debit the intermediary account once for a batch of individual payments.

The present invention provides for a technology supporting methods to facilitate individualized payments to be made to the IRS through such a third party organization without the third party having to pool, batch, lump sum, or other collective grouping for multiple payments.

The present invention provides a method of completing electronic payments from individuals' and business' credit, debit prepaid, ATM card, PayPal account, Bill Me Later account, or other electronic payment methods, hereinafter defined and referred to as individually and collectively as electronic payments, to a taxing authority such as the IRS or state government, or other applicable merchant or payment recipient through a third party facilitator.

Additionally, the present invention provides methods that facilitate individualized electronic payments to be made to the IRS, state tax departments, government agencies, businesses, and other industries or entities, including, by way of example and not limitation, mortgage payments to mortgage companies, banks, credit unions, and/or other lending or financial institutions, through such a third party organization without the third party having to pool multiple payments or requiring the receiving party to accept a separate payment file, if applicable, for reconciliation. The invention is operable to leverage payment channels and networks, including but not limited to the Internet, phone, wireless communications, and other channels, interactive voice response (IVR), mobile, call center live operator, and combinations thereof. Thus, the present invention is immediately applicable without requiring integration, with any merchant, creditor, or payment recipient that currently accepts ACH payments as part of their revenue collection or product/service sales process.

The present invention and preferred embodiments supporting best mode of application thereof as set forth in the foregoing, are supplied as examples and not intended to limit the scope of the invention thereto. The methods of the present inventions are applicable beyond payments to tax authorities within the government. By way of example and not limitation, other applicable areas for the methods of the present invention include the following: the public sector where individual Electronic Payment is not available; the Federal government (e.g., individual income taxes, business taxes); state governments (e.g., individual income taxes, business taxes, sales and use tax, corporate filings, business licenses, hunting and fishing licenses, etc.); local government (e.g., permits, court fees and fines, citations, etc.); private sector, including but not limited to payments for rent (e.g., residential property, commercial property, storage facilities, boat slips, etc.), lending (e.g., mortgage payments, auto loan payments, personal loans, etc.), education (e.g., tuition, room and board, etc.); insurance (e.g., homeowners insurance, auto insurance, life insurance, etc.); credit card (e.g., credit card liability payment); public and private utilities (e.g., water, electric, gas, etc.); collections (e.g., past due debt payments); and combinations thereof.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention as set forth in the claims.

1. A method for processing payments electronically over a network-based system comprising the steps of:
(a) initiating an electronic transaction for making a payment on behalf of an individual;
(b) receiving through a communications network an authorization for receiving payment from an individual account; and
(c) providing payment data to a payment recipient relating to the transaction for making the payment on behalf of the individual by an intermediary through the communications network, wherein the intermediary does not provide individual account information
thereby providing for individual payments to the payment recipient without providing the individual account to the payment recipient.

2. The method of claim 1, wherein the step of providing electronic payment to the payment recipient is made by the intermediary using an intermediary account.

3. The method of claim 1, wherein the steps (a) through (b) are repeated for a multiplicity of individuals and their respective individual accounts.

4. The method of claim 1, wherein step (c) is made on behalf of a multiplicity of individuals, while the payment data provided includes an intermediary account from which the payment is transferred.

5. The method of claim 4, wherein the payment data includes reference data to ensure credit for payment is allocated to each of the multiplicity of individuals.

6. A method for making financial transactions comprising the steps of:
providing a network for making electronic data communications, including secure transmission of payment data for transmitting payments between an intermediary and a payment recipient, with the payment being made by the intermediary on behalf of at least one account payor where payment to the intermediary is made by respective account payor without providing individual account information;
initiating a transaction over the network for making an electronic payment on behalf of at least one account payor owing the payment recipient;
automatically receiving authorization through the network for receiving payment from the at least one account payor;
providing payment data to the payment recipient relating to the payment made directly by the intermediary on behalf of the at least one account payor;
and receiving confirmation of the payment data processing by the payment recipient.

7. The method of claim 6, wherein the payment data includes information relating to an intermediary account for more than one account payor.

8. The method of claim 6, wherein the payment data only includes account information associated with the intermediary.

9. A method for processing payments electronically over a network-based system comprising the steps of:
(a) initiating an electronic transaction for making a payment on behalf of an individual;
(b) receiving electronic authorization through a communication network tor receiving payment from an individual account without providing an individual account associated with the payment made on behalf of an individual;
(c) providing payment data through the network to a payment recipient relating to the transaction for making the payment on behalf of the individual by an intermediary;
and (d) optionally receiving confirmation of the payment data processing or decline thereof by the payment recipient, thereby providing for individual payments to the payment recipient without providing the individual account to the payment recipient.
